(19) United States
(12) Patent Application Publication
(10) Pub. No.: US 2008/0148054 A1
(43) Pub. Date: Jun. 19, 2008

(54) Secure Signatures

(75) Inventors: Jason Cahill, Woodinville, WA (US); Denis X. Charles, Redmond, WA (US); Kamal Jain, Bellevue, WA (US); Kristin E. Lauter, La Jolla, CA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/611,624

(22) Filed: Dec. 15, 2006

(51) Int. Cl. H04L 9/32; G06F 21/00; H04L 9/30

(52) U.S. Cl. 713/176; 713/180; 380/30

(57) ABSTRACT

Systems and methods for secure signatures are described. In one aspect, a secure signature is generated. The secure signature strongly binds an image of an electronic signature (an “electronic signature”) to content in either electronic or printed form. Responsive to receiving a request from a user, the systems and methods determine whether an electronic signature associated with a printed page represents a secure signature. If so, the systems and methods determine and notify the user of whether the secure signature was cryptographically bound by a signer of the electronic signature to the content being signed.

### BACKGROUND

Obtaining a person's hand-written signature is a traditional and useful technique to establish identity and will of the person (a signatory) to execute a document (e.g., a record, contract, memorandum, etc.), and a willingness of the person to be bound by content of the document. Even in this digital age, hand-written signatures are a necessary part of legal agreements, bank and credit card transactions, and contracts of all kinds. When a person hand-signs a document electronically (e.g., with a pen attached to a pen pad device such as a graphics pad, a tablet PC, etc.), a digital image (e.g., a JPEG, TIFF, or other image type) of the signature is attached or logically associated with the document. The digital image of the hand-written signature is an electronic signature that is a legally binding equivalent of the individual's handwritten signature. Using image processing software, a person's electronic signature can typically be cut/copied from a document and pasted/copied into a different document for unauthorized use. Such unauthorized use includes, for example, forgery, spoofing consent, etc. The rapidly rising problem of identity theft illustrates the ease of unauthorized uses of electronic signatures.

### SUMMARY

Systems and methods for secure signatures are described. In one aspect, a secure signature is generated. The secure signature strongly binds an image of an electronic signature (an “electronic signature”) to content in either electronic or printed form. Responsive to receiving a request from a user, the systems and methods determine whether an electronic signature associated with a printed page represents a secure signature. If so, the systems and methods determine and notify the user of whether the secure signature was cryptographically bound by a signer of the electronic signature to the content being signed.

This Summary is provided to introduce a selection of concepts in a simplified form that are further described below in the detailed description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 shows an exemplary system for secure signatures, according to one embodiment.

FIG. 2 shows an exemplary procedure for secure signatures, according to one embodiment.

FIG. 3 shows further operations of the exemplary procedure of FIG. 2 for secure signatures, according to one embodiment.

### DETAILED DESCRIPTION

### Overview

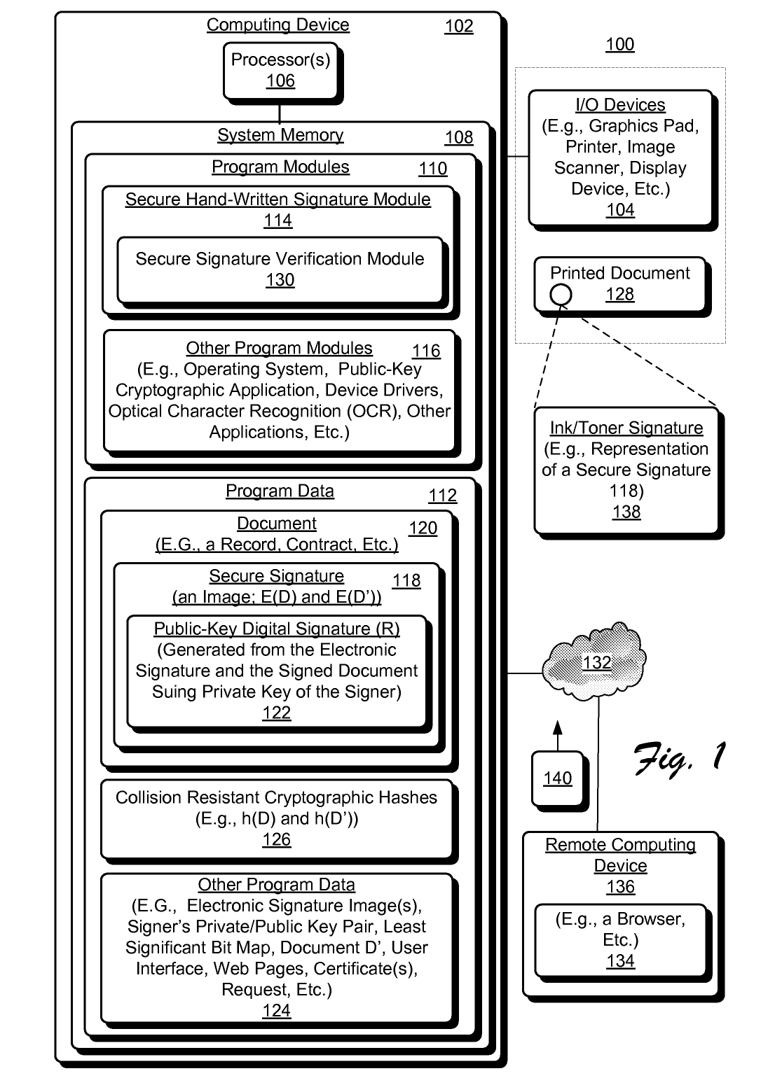

Systems and methods for secure signatures are described below in reference to FIGS. 1 through 3. The systems and methods add security to a digital image of a hand-written signature of a person (i.e., an “electronic signature”), by binding or tying the electronic signature to specific content of the particular digital document being signed. As described below, this also binds a printed version of the electronic signature image (ink/toner at this point) to a printed version of the electronic document. To this end, the systems and methods generate a first collision resistant hash from a combination of the person's electronic signature and content of the electronically signed document. Using a private key of the person/signer, the systems and methods digitally sign the collision resistant hash using one of multiple possible public-key cryptographic techniques. This creates a public-key digital signature. Using a reversible technique (e.g., least significant bit mapping, etc.), the systems and methods insert/embed the public-key digital signature into the bits associated with the electronic signature to generate a “secure signature”. The secure signature comprises a digitally signed fingerprint of the electronic signature together with the original document content that can only be decrypted using the person's public key of the private/public key pair. This secure signature binds the person's signature to the content. At this point, the document can be distributed to end-users for viewing and printing.

To verify whether a person's signature is authentically bound/tied to content of an electronic or printed (non-electronic) document, the systems and methods first determine if the signature is a “secure signature”. As described above, a secure signature includes a public-key digital signature of a hash value generated from the person's electronic signature and the content of the document actually signed by the person. (If the document comprising the signature is a paper/printed document, the document is scanned to generate an electronic document representing the printed document). If the systems and methods do not detect such an embedded public-key digital signature in a digital image of the signature (i.e., the signature is not a secure signature), the systems and methods will not verify that the electronic signature authentically binds the signer to content of the document. For purposes of exemplary illustration, a person's signature could be forged by printing a document comprising a digital image of a secure signature, and tracing over the printed version of the digital image to generate a “clean” signature. In this scenario, the “clean” signature will not contain the programmatically detectable and embedded public-key digital signature of the signer that ties the signer's signature to specific content of a document.

If the systems and methods can extract the public-key digital signature from the signature, the signature represents a secure signature. The extracted public-key digital signature is then decrypted using the public key (of a private/public key pair) of the person/signer. The systems and methods compute a second collision resistant hash of the document content (in this example, the document content comprises a digital image of the person's hand-written signature (i.e., an electronic signature) minus the extracted public-key digital signature). If the first and second hashes match, then the systems and methods verify that the person's signature represents intent by the person to execute the document; otherwise such a relationship is not verified.

These and other aspects for secure signatures are now described in greater detail.

### An Exemplary System

Although not required, systems and methods for secure signatures are described in the general context of computer-executable instructions executed by a computing device such as a personal computer. Program modules generally include routines, programs, objects, components, data structures, etc., that perform particular tasks or implement particular abstract data types. While the systems and methods are described in the foregoing context, acts and operations described hereinafter may also be implemented in hardware.

FIG. 1 shows an exemplary system 100 for secure signatures, according to one embodiment. In this implementation, system 100 includes a computing device 102 such as a general purpose computing device, a server, a laptop, a mobile computing device, a tablet PC, and/or so on. A tablet PC typically includes a touch screen or digitizing tablet technology allowing a user to operate the computer with a stylus or digital pen instead of a keyboard or mouse. In one implementation, computing device 102 is coupled to an I/O device 104 such as a graphics tablet that allows a user to provide/draw a hand-written signature using a stylus (a pen-like drawing apparatus), similar to the way one draws images with a pencil and paper.

Computing device 102 includes one or more processors 106 coupled to a respective tangible computer-readable storage medium such as system memory 108. A processor 106 may be a microprocessor, microcomputer, microcontroller, digital signal processor, etc. System memory 108 includes, for example, volatile random access memory (e.g., RAM) and non-volatile read-only memory (e.g., ROM, flash memory, etc.) for computer-program instructions executable by a processor 106 and program data generated and/or used by the computer-program instructions. Such computer-program instructions are shown as program modules 110 and program data is shown as program data 112. In this implementation, for example, program modules 110 include secure hand-written signatures module 114 and other program modules 116 such as an Operating System (OS) to provide a runtime environment, public key cryptographic application(s), device drivers, etc.

Secure hand-written signatures module 114 (hereinafter often referred to as “secure signatures module 114”) generates a secure signature 118 that cryptographically binds a persons's electronic signature to content of a document 120 (e.g., one or more pages of content representing a record, a contract, and memorandum, official stationery, etc.). An electronic signature represents a digital image version of a hand-written signature of the person (also referred to as the “signer”). Such an electronic signature is shown as a respective portion of “other program data” 124. In one implementation, secure signatures module 114 receives an electronic signature from an I/O device such as a card reader, a graphics pad, etc. For example, in one implementation, a person generates an electronic signature using a pen/stylus attached to a digital pen pad device (e.g., a graphics pad, a tablet PC, etc.). In this scenario, the electronic signature is attached or otherwise logically associated with document 120. At this point, the electronic signature represents a willingness of the user to execute content of document 120 (i.e., a willingness of the user to be bound by content of document 120). In view of this electronic signature, secure signatures module 114 creates a secure signature 118 that cryptographically ties/binds the user's electronic signature to content of document 120 as follows.

Let D be a bitmap of an original document 120 that was electronically signed by a user. Using one of multiple possible known collision resistant cryptographic hash functions (e.g., SHA 1, etc.), secure signatures module 114 generates h(D), which is a collision resistant cryptographic hash (“hash 126”) of D. Secure signatures module 114 generates h(D) from the signer's electronic signature and content of the document 120. Using a public-key cryptographic application/infrastructure (e.g., RSA, DSA, ECDSA, BLS, etc.) and a private key of the user/signer, secure signatures module 114 computes a public-key digital signature 122 (R) from h(D) (note that at this juncture the claimed identity of the signer is verified by the system using the public-key infrastructure). That is, secure signatures module 114 cryptographically signs h(D) to generate R. Secure signatures module 114 then generates secure signature 118 by inserting/embedding or logically associating R (122) into the bits of the electronic signature. In this manner, secure signature 118 cryptographically ties/binds the electronic signature to content of document 120. In one implementation, secure signatures module 114 inserts/embeds (or logically associates) R (122) into the image of electronic signature 118 using a Least Significant Bit (LSB) map technique to preserve readability and legibility of secure signature 118. In one implementation, such an LSB mapping technique creates a faint grayscale image (hash pattern) that encodes values of R. This two-dimensional pattern would be nearly imperceptible to an untrained eye. This two-dimensional pattern, however, can be programmatically identified and extracted from a screen capture or a printed image in a way that could be reconstructed and verified against document content.

In this implementation, secure signatures 114 creates secure signature 118 by embedding R (122) into an electronic signature such that R is visually unobtrusive (e.g., hidden, or invisible) to a viewer. In this implementation, if a user generates a printed document 128 from document 120, the R embedded in the secure signature 118 associated with document 120 is still embedded and represented in the ink/toner version of the secure signature on a page of the printed document 128. As described in greater detail in the following section, signature verification module 130 can detect and extract R from a scanned in bitmap (document D′) of the printed document 128. Thus, operations of secure signatures 114 to generate secure signature 118 bind a signer's electronic signature to a printed page.

A user verifies whether a signer's electronic signature (encapsulated by a secure signature 118) authentically binds the signer to content of a document (i.e., the electronic signature has not been forged, cut and paste, etc., into the document) by interfacing with secure signature validation module 130 of system 100. The user may be interfacing with computing device 102 or remote computing device 136 coupled across a network 132 to computing device 102. (Network 132 may include any combination of a local area network (LAN) and a general wide area network (WAN) communication environments, such as those which are commonplace in offices, enterprise-wide computer networks, intranets, and the Internet). In one implementation, secure signature validation module 130 communicates a user interface (UI) and/or webpages to the user. Such a UI and webpages allow the user to specify a document D′ comprise an electronic signature and a public key of a purported signer of a secure signature 118 comprising the electronic signature. (If the document comprising the signature is a paper/printed document 128, the user scans the printed document 128 to generate an electronic document D′). For purposes of exemplary illustration, such a public key and D′ are represented or specified via request 140 from remote computing device 136.

Signature verification 130 locates a bitmap representing the hand-written signature portion of D′. In one implementation, a user/operator manually identifies the bits associated with signature (e.g., draws a rectangle with a pointing device to define dimensions of the bitmap, etc.). At this point, it is not known whether the identified signature bits comprise a secure signature 118 or a plain, conventional digital image of a person's hand-written signature. (E.g., a forger tracing over a printed version of a secure signature 118 can at most generate an electronic signature. Such a forged signature will not comprise the programmatically detectable and embedded public-key digital signature of the actual/real signer that is in the printed version of the secure signature 118. Secure signature verification 130 attempts to extract a public-key digital signature R (122) from the bits associated with the electronic signature. In one implementation, this is accomplished by reading off the least significant bits of the pixel intensity values associated with the identified portion. If a public-key digital signature R is not present, the electronic signature in the identified portion is not a secure signature 118 (i.e., there is no cryptographic tie of the electronic signature to content of D′) and module 130 notifies the user that authenticity of the signature with respect to the content of document D′ cannot be verified.

If a digital signature R is extracted from the electronic signature in the identified portion, the electronic signature is a secure signature 118. The extraction operations clear/zero-out the pixel intensity values in the identified secure signature 118, resulting in a plain electronic signature. Once the electronic signature has been extracted, the signature verification follows the digital signature protocol selected for the scheme. In more detail, signature validation 130 decrypts the extracted digital signature R using the received public-key to identify a first collision resistant cryptographic hash value h(D) 126. In one implementation, in the case of an RSA digital signature R, this would involve exponentiation of R using the public key of the signer and a check/evaluation to see if the result matches the published certificate/key of the signer. Signature verification 130 then computes a second collision resistant hash h(D′) of D′, which comprises the content and the electronic signature. (At the point that h(D′) is calculated, D′ still includes the electronic signature 118, but the electronic signature is no longer a secure signature 118 in that it no longer comprises an embedded digital signature R).

Signature validation logic 130 compares the first and second hash values 126. If the first and second hash values 126 are the same, signature validation 130 notifies the user that the electronic signature encapsulated in the secure signature 118 represents a willingness of the author/signer to be bound to the content of D′. Otherwise, signature validation 130 notifies the user that electronic signature does not represent a willingness of the author/signer to be bound to the content of D′.

### Exemplary Procedure

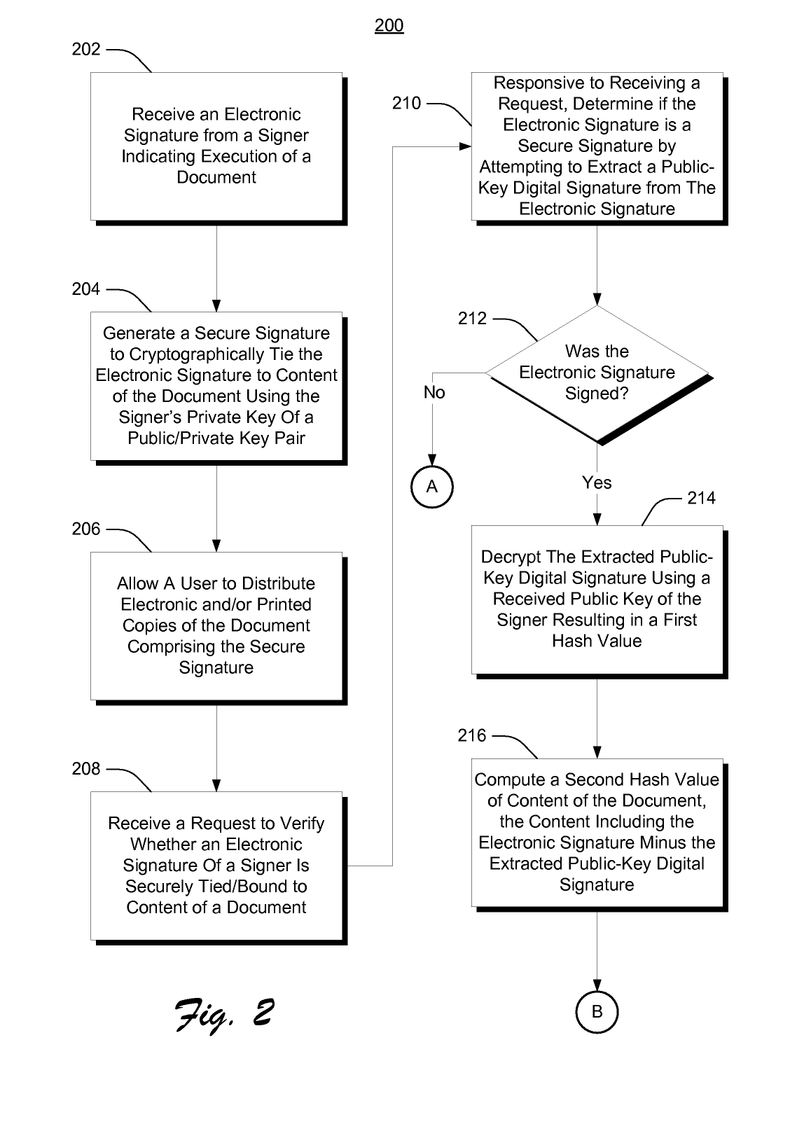

FIG. 2 shows an exemplary procedure 200 for secure signatures, according to one embodiment. For purposes of exemplary description, operations of procedure 200 are described with respect to certain components of FIG. 1. In the description, the leftmost numeral of a reference number indicates the particular figure where the component was first introduced. In one implementation, respective ones of secure signature module 114 and secure verification module 130 implement the operations of procedure 200. Operations at block 202 receive an electronic signature from a signatory/signer indicating execution of a document 120. Operations of block 204 augment the electronic signature to generate a secure signature 118 that cryptographically ties the electronic signature to content of the document 120. In one implementation, this is accomplished by generating a collision resistant hash from content of document 120 and the electronic signature. This collision resistant hash is then cryptographically signed using a public-key cryptographic infrastructure to generate a public-key digital signature 122. In this implementation, the operations of block 204 insert the public-key digital signature 122 into the electronic signature 118 to generate the secure signature 118. In this manner, secure signature 118 cryptographically ties/binds a signers' electronic signature to specific content of document 120. For instance, a secure signature 118 cut from an original document and pasted into a different document will not be cryptographically tied to the content of the different document.

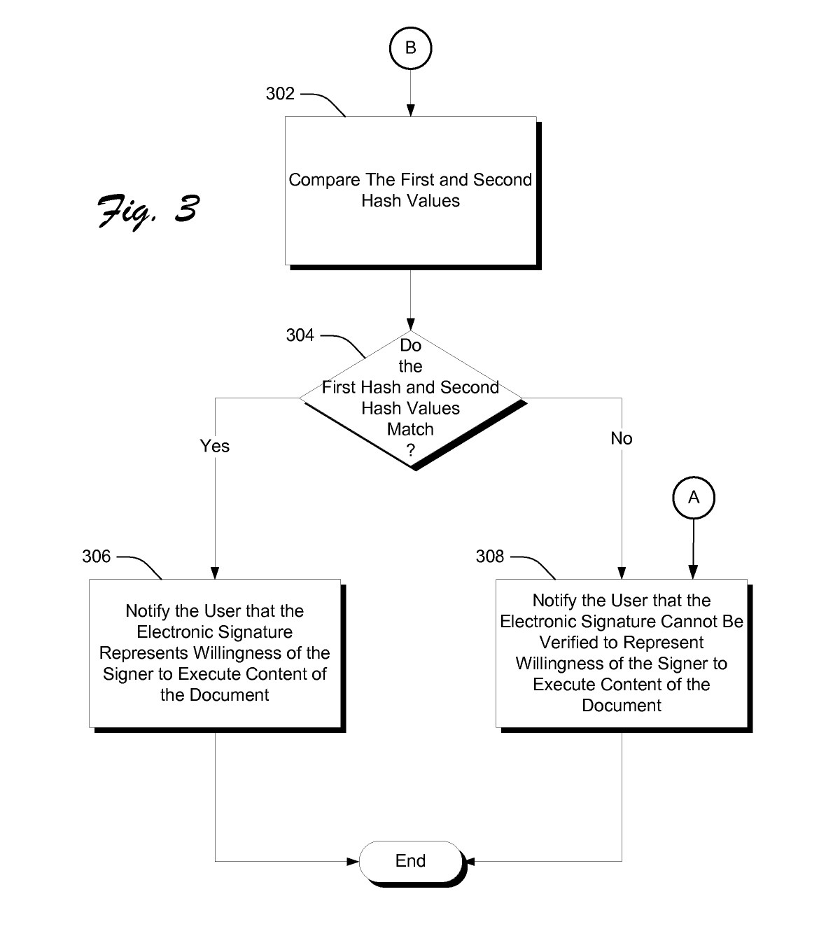

Operations at block 208 receive a request to verify whether an electronic signature of a signer is securely tied/bound to content of a document D′. The request includes (or otherwise identifies) the document D′ to be verified as well as a public key of a private/public cryptographic key pair of the purported document signer. Operations of block 210 attempt to extract a public-key digital signature R (122) from the electronic signature embedded or logically associated with the received document. If such a public-key digital signature R is present in the electronic signature, the electronic signature is a secure signature 118. The extraction operations remove/strip-out (e.g., zero-out) any indication R from the electronic signature. Operations of block 212 determine if a public-key digital signature R was found in the electronic signature. If the electronic signature was not digitally signed, operations of procedure 200 continue at on-page reference “A” of FIG. 3, where the user is notified that electronic signature associated with D′ cannot be verified to represent willingness of the signer to execute content of the document D′. Otherwise, operations of block 214 decrypt the extracted public-key digital signature R (122) using the public-key of the signer (the public-key was received in the request associated with operations of block 202). These decryption operations result in a first hash value h(D) 126. Operations of block 216 compute a second hash value 126 (i.e., a collision resistant hash value) from content of the document D′ and the electronic signature, which was stripped of the extracted public-key digital signature (please see operations of block 210). At this point, operations of procedure 200 continue at on-page reference “B” of FIG. 3.

FIG. 3 shows further operations of the exemplary procedure 200 of FIG. 2 for secure signatures, according to one embodiment. Operations of block 302 compare the first and second hash values 126 (please refer to the previously described operations of block 216 of FIG. 2). As indicated above, the first hash value 126 was the result of decrypting the public-key digital signature 122 associated with the secure signature 118 embedded or logically associated with the document D′ (120). The second hash value 126 was calculated using a collision-resistant hash function from content of document D′ and the corresponding electronic signature (the secure signature 118 stripped of the digital signature). If the first hash value 126 is the same as the second hash value 126, operations of block 304 continue at block 306. Operations of block 306 notify the user (i.e., the requester of block 202 of FIG. 2) that the electronic signature associated with the document D′ represents willingness of the signatory to execute content of the document D′. If the first hash value 126 is not the same as the second hash value 126, operations of block 304 continue at block 308. Operations of block 308 notify the user that the electronic signature associated with the document D′ cannot be verified to represent willingness of the signatory to execute (e.g., be bound to) content of the document. At this point, operations of procedure 200 terminate.

### Conclusion

Although secure signatures has been described in language specific to structural features and/or methodological operations or actions, it is understood that the implementations presented in the appended claims are not necessarily limited to the specific features or actions described above. For example, although operations associated with secure hand-written signature module 114 (FIG. 1) are shown and described as encapsulating operations for signature verification module/logic 130, operations of these respective program modules can be independent from one another. In one implementation, for example, operations of secure hand-written signature module 114 do not encapsulate operations of module 130, but are instead implemented completely independent of such operations. In one implementation, for example, operations of module 114 are implemented on a different computing device then operations of module 130. Accordingly, the specific features and operations discussed above are disclosed as exemplary forms of implementing the following claimed subject matter.

1. A computing device comprising:
a processor; and
a memory coupled to the processor, the memory comprising computer-program instructions executable by the processor, the computer-program instructions when executed by the processor for performing operations comprising:
receiving an electronic signature; and
generating a secure signature that securely binds the electronic signature to content of a printed page, the binding being such that a cryptographic-based verification operation can programmatically verify that an author of the electronic signature expressed a willingness to be bound to the content of the printed page.

2. The computing device of claim 1, wherein the secure signature is incorporated into the electronic signature in a manner that is visually hidden from a viewer of the printed page.

3. The computing device of claim 1, wherein the computer-program instructions for generating the secure signature further comprise instructions for:
computing a collision-resistant hash value from content of a document and the electronic signature, the document being in memory associated with the computing device, the printed page representing a printed version of the document;
cryptographically signing the collision resistant hash value to generate a secure digital signature; and
embedding the secure digital signature into bits associated with the electronic signature.

4. The computing device of claim 3 wherein cryptographically signing the collision resistant hash value further comprises cryptographically signing, using a public-key cryptographic application, the collision resistant hash value using a private key of the author, the private key being one of a private/public key pair of the author for digitally signing content using the public-key cryptographic application.

5. The computing device of claim 3 wherein embedding the secure digital signature further comprises inserting the secure digital signature into the electronic signature using a least significant bit algorithm.

6. The computing device of claim 1, wherein the computer-program instructions further comprise instructions for:
receiving a request from a user to verify that an electronic signature associated with the printed page actually represents a willingness of a signatory of the electronic signature to execute content of the printed page, the request identifying an electronic version of the content and a public key of the author;
determining whether the electronic signature comprises a secure digital signature;
if the electronic signature does not comprise the secure digital signature, notifying the user that the electronic signature cannot be verified to represent willingness of the author to execute the content; and
if the electronic signature comprises the digital signature verifying, using the public key, whether the electronic signature represents an willingness of the author to execute the content.

7. The computing device of claim 6, wherein the secure digital signature is a public-key digital signature generated using a public-key cryptographic application and a private-key of the signatory.

8. The computing device of claim 6 wherein the computer-program instructions for verifying further comprise instructions for:
decrypting the secure digital signature with the public-key to identify a first hash value;
calculating a second hash value from the content and the electronic signature independent of the secure digital signature;
if the first hash value matches the second hash value, notifying the user that the electronic signature is bound to the content; and
if the first hash value does not match the second hash value, notifying the user that the electronic signature is not bound to the content.

9. A tangible computer-readable data storage medium comprising computer-program instructions executable by a processor, the computer-program instructions when executed by the processor for performing operations comprising:
cryptographically tying a person's electronic signature to content of a document by:
digitally signing content of the document and the electronic signature to create a digital signature;
embedding the digital signature into bits associated with the electronic signature to generate a secure signature;
distributing the document comprising the secure signature to end-users for viewing and authentication.

10. The computer-readable data storage medium of claim 9, wherein the electronic signature was obtained from a printed document.

11. The computer-readable data storage medium of claim 9, wherein digitally signing further comprises:
generating a collision-resistant hash from the content and the electronic signature;
digitally signing the collision resistant hash using a private key of the person to generate the digital signature, the private key being a key of a private/public key pair used for public-key cryptographic operations; and
wherein the digital signature can be decrypted with only the public key of the private/public key pair.

12. The computer-readable data storage medium of claim 9, wherein the bits comprise least significant bits associated with the electronic signature.

13. A computer-implemented method comprising:
receiving a request from a user to verify that an electronic signature associated with a document is cryptographically bound by a signer of the electronic signature to content of the document;
evaluating bits of the electronic signature to determine whether the bits represent an embedded digital signature;
if the bits do not represent the embedded digital signature, notifying the user that the electronic signature is not cryptographically bound to content of the document; and
if the bits do represent the embedded digital signature, verifying whether the electronic signature was cryptographically bound by the signer to the content.

14. The method of claim 13, wherein the document is an electronic document generated from a non-electronic document.

15. The method of claim 13, wherein the request identifies the document, the electronic signature being part of the document, attached to the document, or logically associated with the document.

16. The method of claim 13, wherein the bits are least significant bits.

17. The method of claim 13, wherein verifying whether the electronic signature was cryptographically bound by the signer to the content further comprises using public-key cryptographic techniques to determine whether the electronic signature was bound by the signer to the content.

18. The method of claim 13, wherein verifying whether the electronic signature was cryptographically bound by the signer to the content further comprises:
decrypting the embedded digital signature with a public key of a private/public key pair of the signer to obtain a first hash value;
removing the embedded digital signature from the electronic signature;
calculating a second hash value from the content and the electronic signature; and
if the first hash value matches the second hash value, indicating to the user that the electronic signature was cryptographically bound by the signer to the content.

19. The method of claim 18, wherein the first and second hash values are collision resistant.

20. The method of claim 18, wherein the method further comprises notifying, if the first hash value does not match the second hash value, the user that the electronic signature was not bound by the signer to the content.
